(19) United States
(12) Patent Application Publication
(10) Pub. No.: US 2021/0101565 A1
(43) Pub. Date: Apr. 8, 2021

(54) DEVICE FOR CLEANING A VEHICLE WINDOW

(71) Applicant: VALEO SYSTEMES D'ESSUYAGE, La Verriere (FR)

(72) Inventors: Gerald CAILLOT, La Verriere (FR); Jean Michel JARASSON, La Verriere (FR); Vincent IZABEL, La Verriere (FR)

(73) Assignee: VALEO SYSTEMES D'ESSUYAGE, La Verriere (FR)

(21) Appl. No.: 17/060,160

(22) Filed: Oct. 1, 2020

(30) Foreign Application Priority Data
Oct. 4, 2019 (FR) 1911042

(51) Int. Cl. B60S 1/52; B05B 7/00; B60S 1/38; B60S 1/40

(52) U.S. Cl. CPC B60S 1/524; B60S 1/4038; B60S 1/3862; B05B 7/005

(57) ABSTRACT

The invention relates to a device for cleaning a vehicle window that includes a foam generator that is configured to draw in air and a cleaning fluid (L) and mix them and at least partially convert them into a foam form; and further includes, a regulating means for regulating the air flow drawn in by the foam generator and a control unit that is configured to control an air flow regulating means on the basis of at least one parameter.

### CROSS-REFERENCE TO RELATED APPLICATIONS

This application claims the priority date benefit of French application No. 1911042 filed Oct. 4, 2019, the disclosure of which is incorporated by reference herein in its entirety.

### TECHNICAL FIELD

The present invention relates to a device for cleaning a window, and notably a windscreen, of a motor vehicle. In particular, the invention relates to a cleaning device provided with a foam generator, that mixes the cleaning fluid with air to distribute it in the form of foam. The cleaning fluid is then applied to the windscreen by nozzles placed on the vehicle windscreen wipers.

Window cleaning devices are used to clean dirt off the windows, and especially the windscreen, of the vehicle. This dirt is, for example, splashes of mud, squashed insects, dust, etc.

### BACKGROUND

In order to do this, the window cleaning devices use nozzles to distribute a cleaning fluid. The cleaning fluid is generally water-based, with the addition of surfactants and antifreeze products (methanol, etc.). In combination with the windscreen wipers, the cleaning device keeps the window or windscreen clean and transparent for better visibility.

It is known practice to mix a proportion of air with the cleaning fluid, by means of a foam generator, and then distribute it over the window in the form of foam. In order to distribute the foam as close as possible to the windscreen wipers, the said wipers may bear nozzles via which the foam is emitted.

### SUMMARY

Distribution in the form of foam offers the advantage that a determined level of cleanliness can be achieved with a smaller quantity of fluid. Injecting air in the form of bubbles also contributes to the dissolving of oily dirt, and the pressure may make a mechanical contribution to the cleaning.

However, while cleaning with foam yields satisfactory results under controlled conditions (low speeds, temperature that is neither too high nor too low, etc.), problems occur under conditions which are nevertheless commonly encountered by a vehicle in its travels. Specifically, the foam is particularly prone to evaporate, to freeze, and to be carried away aerodynamically with the air flowing around the vehicle at high speed.

Thus there arises the technical problem of improving cleaning under the variable and potentially extreme conditions of travel of the motor vehicle.

In order to at least partially overcome the above-mentioned problems, one subject of the invention is a device for cleaning a vehicle window, comprising:

a foam generator (7), configured to draw in air and a cleaning fluid (L) and mix the air and the cleaning fluid (L) and at least partially convert them into a foam,

characterized in that it further comprises:

regulating means (75) for regulating the air flow drawn in by the foam generator (7),

a control unit (9) configured to control the air flow regulating means (75) on the basis of at least one parameter.

By adapting the air flow and therefore the proportion of foam in the fluid sprayed onto the window, optimal cleaning can be afforded with a potentially smaller quantity of fluid, and this can be achieved under numerous conditions.

The device may also have one or more of the following features, taken separately or in combination:

The air flow regulating means may comprise air duct shutters.

The air flow regulating means may comprise a controlled-delivery pump.

The control unit may be configured to reduce the air flow drawn in as the speed of the vehicle increases.

The control unit may be configured to cut off the air flow drawn in when the speed exceeds a predetermined threshold.

The control unit may be configured to modify the air flow drawn in by the foam generator on the basis of a state of cleanliness of the window that is detected after a first cycle of cleaning of said window.

The device may further comprise an optical camera directed onto the window of the vehicle in order to detect the state of cleanliness of the window.

The control unit may be configured to detect successive and closely-spaced uses of the device corresponding to insufficient cleaning, and to change the air flow drawn in by the foam generator in response.

The foam generator may comprise two air inlets, one admitting heated air, and the other admitting exterior air, and a valve controlled by the control unit so that a controlled proportion of air from each of the air inlets is mixed with the cleaning fluid in the foam generator.

The control unit may be connected to a thermometer that measures the temperature of the intake air, and may be configured to increase the proportion of air derived from the heated-air inlet when a low temperature is detected.

The control unit may be configured to adapt the air flow drawn in by the foam generator on the basis of the phase of a windscreen wiper sweep cycle.

The control unit may be configured to increase or decrease the air flow when the windscreen wipers reach specific angles in the sweep.

The device may further comprise a composition detector detecting the composition of the cleaning fluid, and configured to identify at least one component of said fluid and estimate the proportion of the cleaning fluid that said component represents, and the control unit may be configured to adapt the air flow drawn in by the foam generator on the basis of the presence and/or of the proportion of said component.

The composition detector may comprise an optical detector, a viscosity detector, or a capacitive detector.

The device may further comprise:

a reservoir of cleaning fluid, configured to contain a volume of cleaning fluid,

a cleaning-fluid pump, configured to displace the cleaning fluid from the reservoir,

at least one distribution nozzle distributing cleaning fluid over at least a portion of a vehicle window, and configured to be arranged in a windscreen wiper of the vehicle,

fluid ducts, guiding the cleaning fluid from the reservoir towards the at least one distribution nozzle.

### BRIEF DESCRIPTION OF THE DRAWINGS

Further features and advantages of the invention will become more clearly apparent from reading the following description, given by way of non-limiting illustrative example, and from the attached drawings, in which:

FIG. 1 is a schematic depiction of a windscreen and of the associated cleaning device,

FIG. 2 is a graph of the proportion of air added as a function of the speed of travel,

FIG. 3 is a schematic depiction of a foam generator with two air inlets,

FIG. 4 is a graph of the proportion of air added as a function of temperature for the embodiment of FIG. 3,

FIG. 5 is a linear flow diagram indicating the steps of one way of regulating the air flow,

FIG. 6 is a schematic depiction of a window towards which an optical level-of-cleanliness detector is directed,

FIG. 7 and FIG. 8 are schematic depictions of a window with the windscreen wipers in various phases of their sweep cycle, and

FIG. 9 is a schematic depiction of a cleaning device comprising a detector that detects components of the cleaning fluid.

### DETAILED DESCRIPTION

In all the figures, the same references relate to the same elements. The embodiments described with reference to figures are examples.

Although the description refers to one or more embodiments, this does not necessarily mean that each reference relates to the same embodiment, or that the features apply only to a single embodiment. Single features of various embodiments can also be combined to create other embodiments.

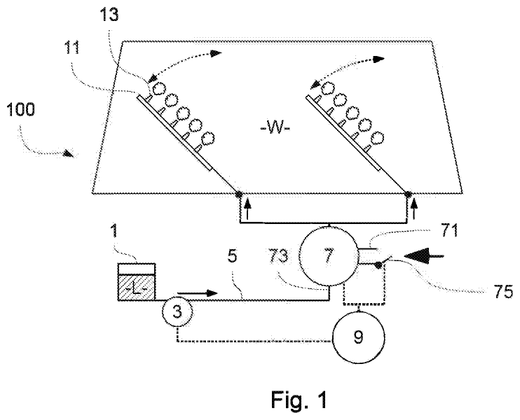

FIG. 1 illustrates a cleaning device 100 according to a first embodiment of the invention.

Cleaning device 100 of FIG. 1 comprises a reservoir 1 of cleaning fluid to contain a volume of cleaning fluid L. The cleaning fluid L is, for example, a water-based cleaning fluid with the addition of surfactants, solvents and/or antifreeze liquids.

Pump 3 displaces the cleaning fluid L from the reservoir 1 and injects it into ducts 5 connected to the pump 3 and the reservoir 1.

The ducts 5 carry the cleaning fluid towards a foam generator 7.

The foam generator 7 comprises two inlets 71, 73, these being an air inlet 71 and a fluid inlet 73.

In particular, ducts 5 carry the cleaning fluid L as far as the fluid inlet 73. Just one single duct 5 has been depicted in FIG. 1, but embodiments comprising multiple parallel ducts are possible. The air inlet 71 admits air, through the Venturi entrainment effect of the circulation of the cleaning fluid L or through the action of a dedicated pump. The air and the fluid are then mixed in one or more mixing structures or chambers (not depicted) to form a foam.

The air inlet 71 of the foam generator 7 comprises flow regulating means 75, for example a valve or shutter. In an alternative, the flow regulating means 75 may comprise a controlled-delivery air pump.

A control unit 9 controls the flow regulating means 75, the operation of the pump 3 and of the foam generator 7. The control unit 9 notably comprises computing means, with a programmed or programmable memory. The control unit 9, and particularly the computing means and memory thereof, may be either in the form of a dedicated unit or integrated into on-board electronics of the vehicle.

Starting from the foam generator 7, the foam is directed via the ducts 5 towards windscreen wipers 11 which comprise nozzles 13. The cleaning fluid L, partially or completely in the form of foam, is then sprayed via the nozzles 13 onto the windscreen W of the vehicle. Another window or glazed surface of the vehicle may replace the windscreen W. For example, the cleaning device 100 may be positioned at a rear window of the vehicle.

By adjusting the air flow and the flow of fluid in the foam generator 7, the control unit 9 is able to modify the proportion of foam and the properties thereof at the nozzles 13 and at the windscreen W (fluid/foam ratio, density and diameter of bubbles, etc.).

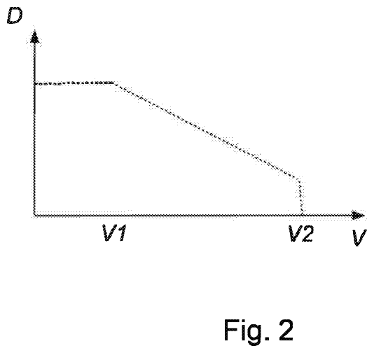

FIG. 2 is a graph illustrating the air flow D entering the foam generator 7 and, therefore, indirectly illustrating the proportion of foam sprayed onto the windscreen W as a function of the speed of travel of the vehicle V.

The horizontal axis corresponds to the speed V of the vehicle (in km·h⁻¹) and the vertical axis corresponds to a rate of air flow D (or a proportion of foam) mixed into the fluid L sprayed against the windscreen W in L·s⁻¹ (or as a percentage of foam).

The proportion of foam is high at low speed. As mentioned above, the use of foam makes it possible to economize on cleaning fluid L. For relatively low speeds, for example below a first speed V1 of 30 or 40 km·h⁻¹, the proportion of foam is constant, corresponding for example to optimum cleaning potential. When the speed of the vehicle exceeds said first speed V1, the proportion of foam decreases progressively, as far as a second speed V2, for example of 90 or 100 km·h⁻¹, at which it becomes zero.

The control unit 9 is for this purpose programmed to reduce the air flow as the speed increases, and to cut off the air flow beyond the second speed V2.

Because foam is more prone than fluid to being carried off by the surrounding stream of air, reducing the air flow and/or the proportion of foam at high speeds makes it possible to avoid massive amounts of cleaning fluid being carried away in the form of foam.

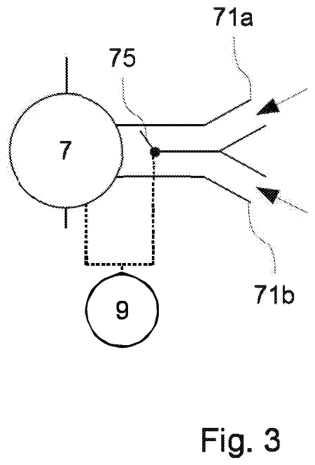

FIG. 3 is a partial schematic depiction of an alternative embodiment of the cleaning device 100, notably of the foam generator 7 and control unit 9 thereof.

In FIG. 3, the cleaning device 100 depicted comprises a foam generator 7 having two air inlets 71a, 71b.

One of the air inlets 71a is connected to an exterior air intake, the other air inlet 71b is connected to an intake for air that has been heated, for example by flowing around a heat exchanger of the engine of the vehicle, or in the engine compartment. As an alternative or in addition, a dedicated heating device may heat the air.

In this instance, selector 75, in the form of a pivoting flap, makes it possible to modify the ratio between the exterior air from the first air inlet 71a and the heated air coming from the second air inlet 71b, by closing off the air ducts 71a, 71b to greater or lesser extents.

For that reason, control unit 9 is connected to a thermal sensor (not depicted), which may be a dedicated or shared resource, for example shared with a vehicle-interior interface that indicates the exterior and interior temperatures. The thermal sensor evaluates the exterior temperature

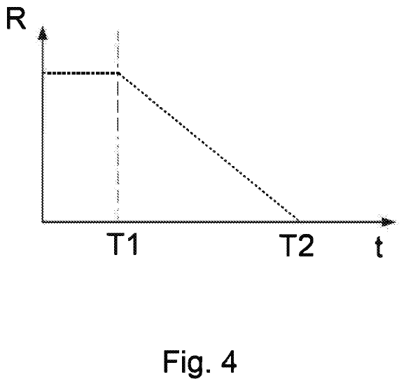

FIG. 4 is a graph illustrating the exterior-air/heated-air ratio R as a function of the exterior temperature t.

If the exterior temperature is low, particularly below a low temperature T1, the control unit 9 actuates the selector so that the air entering the foam generator 7 contains a significant proportion of heated air, for example more than 70% of the total flow, notably exclusively heated air.

The low temperature T1 corresponds for example to the temperature at which the fluid L freezes. The addition of heat from the heated air serves to prevent the said fluid L from immediately freezing onto the windscreen W.

When the temperature exceeds the low temperature T1, but is still below a high temperature T2, the control unit 9 actuates the selector 75 so that the proportion of heated air decreases as the temperature progresses from T1 to T2, for example linearly.

When the high temperature T2 is reached, the proportion of heated air is minimal if not zero. At temperatures higher than the high temperature T2, the proportion of heated air remains minimal if not zero.

The air flow may alternatively or additionally be adjusted when insufficient cleaning is detected after a first cleaning cycle. What is meant here by a cleaning cycle is a spray of fluid accompanied by a series of sweep cycles by the windscreen wipers 11.

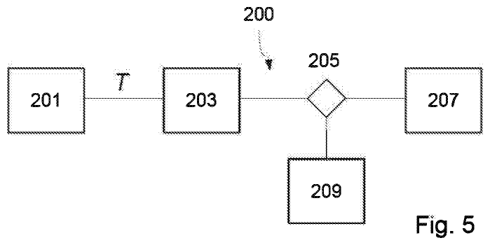

FIG. 5 is a linear flow diagram illustrating a method 200 for detecting insufficient cleaning.

The first step 201 of the method is a first manual actuation of the cleaning device 100 by a user. The second step 203 is a second manual actuation of the cleaning device 100. This second actuation occurs after a time T that has elapsed since the first actuation 201.

In order to determine the quality of the cleaning, the control unit 9 during a third step 205 compares the time T elapsed between the manual actuations against a reference time-lapse T0, for example of 10 to 15 seconds.

If the time T is longer than the reference time-lapse T0, the control unit 9, during a fourth step 207, keeps the rate of air flow at its value used.

If the time T is shorter than the reference time-lapse T0, the control unit 9 will, during a fifth step 209, modify the rate of air flow, for example reducing it, so that a proportion of the fluid L reaches the windscreen W in liquid form.

This is because two closely-spaced actuations generally signify that the cleanliness achieved with the first actuation was insufficient. If, on the other hand, the successive actuations are widely spaced, that generally means that they correspond to two separate cleaning operations.

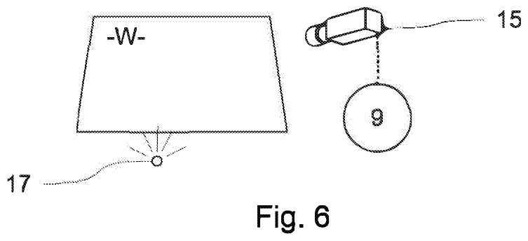

FIG. 6 is a schematic depiction of a cleanliness measurement device for a cleaning device 100 according to one particular embodiment that may be an alternative or an addition to the preceding one.

The cleanliness measurement device comprises a camera 15, notably an infrared camera, directed at the windscreen W, and connected to the control unit 9. A diode 17 illuminates the windscreen W in the infrared domain.

The camera 15 may notably be integrated into the roof of the vehicle, into the rear-view mirror or into a roof-mounted lighting module. The diode 17 may notably be positioned at the level of the vehicle instrument panel.

The infrared light from the diode 17 passes through the windscreen when the latter is clean and transparent, and is scattered by dirt. By evaluating the light intensity scattered by the dirt and picked up by the camera 15, the control unit 9 is therefore able to estimate the level of cleanliness of the windscreen W.

If a sufficient difference in brightness is observed between the measurements before and after a cleaning operation, the control unit 9 maintains the rate of air flow entering the foam generator 7. Conversely, if the difference is insufficient, the rate of intake air flow is modified.

The rate of air flow can also be adjusted on the basis of the phase of the sweep cycle of the windscreen wipers 11.

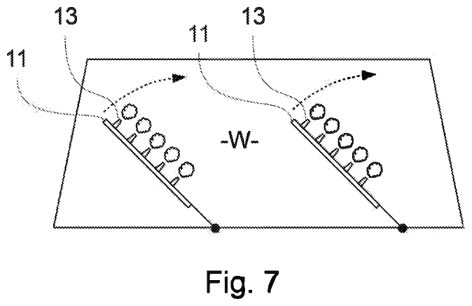

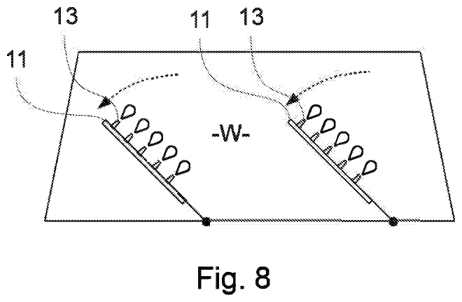

FIGS. 7 and 8 for example illustrate such operation.

FIGS. 7 and 8 are a schematic depiction of the windscreen W, with the windscreen wipers 11 bearing the nozzles 13 oriented towards the top of the windscreen W.

In FIG. 7, the windscreen wipers 11 are in an upsweep phase. The control unit 9 (not depicted in FIG. 7) is therefore configured to inject air into the foam generator 7. The fluid L is therefore sprayed against the windscreen in the form of foam.

The air circulation caused by the movement of the vehicle, and the action of the wipers 11, therefore both carry the foam in the same direction so that pooling of foam (which reduces visibility) is avoided.

As an alternative or in addition, the air flow rate may be reduced and increased when the wipers 11 reach predetermined angles; it is then possible to reduce the volume of fluid that passes over the top of, or beyond, the end of the wipers 11.

In FIG. 8, the windscreen wipers 11 are in a downsweep phase. The control unit 9 (not depicted in FIG. 7) is therefore configured to cut off the injection of air into the foam generator 7. The fluid L is therefore sprayed against the windscreen in the form of a liquid.

Specifically, during the downsweep phase, the carrying effect of the air around the moving vehicle contributes to the spreading of the fluid L over the windscreen W. The fluid L spread out in this way in the form of a foam would reduce visibility, and would be more susceptible to being carried off.

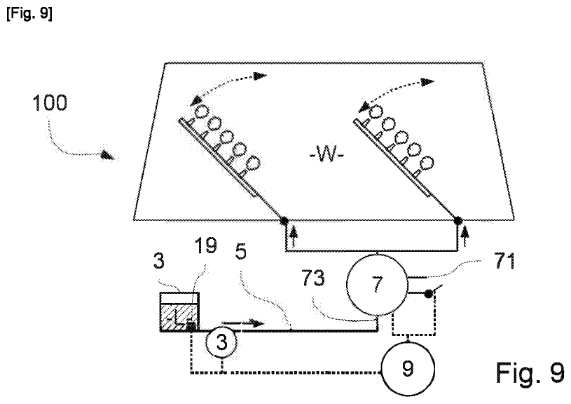

FIG. 9 is a schematic depiction of a cleaning device 100 similar to FIG. 1.

The device 100 in FIG. 8 comprises a composition detector 19 detecting the composition of the cleaning fluid L, and in this instance positioned in the reservoir 1 of cleaning fluid L. According to alternative embodiments, the composition detector may be positioned in the ducts 5.

The composition detector 19 is, for example, an optical detector, a viscosity detector, or a capacitive detector.

The composition detector 19 is configured to identify at least one component and estimate the proportion of the cleaning fluid L that said component represents. The control unit 9 is therefore configured to adapt the air flow drawn in by the foam generator according to the presence and/or proportion of said component.

For example, the composition detector 19 may detect the proportion of the cleaning fluid L that the methanol represents. If the said proportion is greater than 10 or 15% of the cleaning fluid L, the control unit 9 may then cut off the air flow so as to use the cleaning fluid L in the pure and liquid form on the windscreen W.

According to another embodiment, the composition detector 19 may be configured to look for specific compositions, characteristic of specialist cleaning fluids (specifically acting against insects, oils, etc.) which should advantageously be used in the pure and liquid form. If a specialist cleaning fluid L is detected, the control unit 9 may then cut off the air flow.

By adapting the air flow entering the foam generator 7, it is possible to adapt the foam proportion of the cleaning fluid L that is sprayed onto the windscreen W, according to various parameters.

What is claimed is:

1. A device for cleaning a window (W) of a vehicle, comprising:
a foam generator, configured to draw in air and a cleaning fluid (L) and mix the air and the cleaning fluid (L) and at least partially convert the air and the cleaning fluid into a foam, characterized in that the device further comprises:
a regulating means for regulating air flow drawn in by the foam generator,
a control unit configured to control the regulating means of air flow on a basis of at least one parameter.

2. The device according to claim 1, characterized in that the air flow regulating means comprise a number of air duct shutters.

3. The device according to claim 1, characterized in that the air flow regulating means comprises a controlled-delivery pump.

4. The device according to claim 1, characterized in that the control unit is configured to reduce the air flow drawn in as the speed of the vehicle increases.

5. The device according to claim 4, characterized in that the control unit is configured to cut off the air flow drawn in when the speed of the vehicle exceeds a predetermined threshold.

6. The device according to claim 1, characterized in that the control unit is configured to modify the air flow drawn in by the foam generator on the basis of a state of cleanliness of the window (W) that is detected after a first cycle of cleaning the window (W).

7. The device according to claim 6, characterized in that it further comprises an optical camera directed onto the window (W) of the vehicle in order to detect the state of cleanliness of the window (W).

8. The device according to claim 6, characterized in that the control unit is configured to successively detect closely-spaced uses of the device corresponding to insufficient cleaning, and to change the air flow drawn in by the foam generator in response to a detection.

9. The device according to claim 1, characterized in that the foam generator comprises two air inlets, one admitting heated air, and the other admitting exterior air, and a valve controlled by the control unit so that a controlled proportion of air from each of the air inlets is mixed with the cleaning fluid (L) in the foam generator.

10. The device according to claim 9 wherein the control unit is connected to a thermometer that measures a temperature of an intake air, characterized in that the control unit is configured to increase the proportion of air derived from the heated-air inlet when a low temperature is detected.

11. The device according to claim 1, characterized in that the control unit is configured to adapt the air flow drawn in by the foam generator on the basis of a phase of a windscreen wiper sweep cycle.

12. The device according to claim 11, characterized in that the control unit is configured to increase or decrease the air flow when a number of windscreen wipers reach specific angles in the sweep.

13. The device according to claim 1, characterized in that it further comprises a composition detector detecting the composition of the cleaning fluid (L), and configured to identify at least one component of said fluid and estimate the proportion of the cleaning fluid (L) that said component represents, and in that the control unit is configured to adapt the air flow drawn in by the foam generator on the basis of the presence or of the proportion of said component.

14. The device according to claim 13, characterized in that the composition detector comprises an optical detector, a viscosity detector, or a capacitive detector.

15. The device according to claim 1, characterized in that it further comprises:
a reservoir of cleaning fluid, configured to contain a volume of cleaning fluid (L),
a cleaning-fluid pump, configured to displace the cleaning fluid (L) from the reservoir,
at least one distribution nozzle distributing cleaning fluid over at least a portion of the window (W), and configured to be arranged in a windscreen wiper of the vehicle,
a number of fluid ducts, guiding the cleaning fluid (L) from the reservoir towards the at least one distribution nozzle.
